SEQUENCE LISTING (2 sequences)

SEQ ID NO: 1 - DNA, 27 bp, Artificial Sequence
  Description of Artificial Sequence; note = synthetic construct
atgcacccattggacataaccgggaat

SEQ ID NO: 2 - DNA, 27 bp, Artificial Sequence
  Description of Artificial Sequence; note = synthetic construct
attcccggttatgtccaatgggtgcat

(19) United States
(12) Patent Application Publication
(10) Pub. No.: US 2005/0224761 A1
(43) Pub. Date: Oct. 13, 2005

(54) Thermostable and monoconjugatable gold cluster complexes

(76) Inventors: Gunther Von Kiedrowski, Bochum (DE); Wolf Matthias Pankau, Bochum (DE); Sven Monninghoff, Gevelsberg (DE)

Correspondence Address: NEEDLE & ROSENBERG, P.C., SUITE 1000, 999 PEACHTREE STREET, ATLANTA, GA, 30309-3915, US

(21) Appl. No.: 10/514,092

(22) PCT Filed: May 12, 2003
(86) PCT No.: PCT/EP03/04924

§ 371 Date: Mar. 15, 2005

(30) Foreign Application Priority Data
May 10, 2002 (EP) 02010593.8

(51) Int. Cl. G01N 31/00

(52) U.S. Cl. 252/408.1

(57) ABSTRACT

The present invention provides a conjugatable metal cluster complex comprising a metal cluster of type Mk and a multivalent thioether ligand comprising at least two ligand subunits and having one reactive site or one protected reactive site which can be rendered reactive for conjugation, and each of said subunits having at least three thioether moieties, the thioether ligand, its production, and the use of the complex for PCR, labeling, fluorescence quenching and identification.

The present invention provides a conjugatable metal cluster complex comprising a metal cluster of type Mₖ and a multivalent thioether ligand comprising at least two ligand subunits and having one reactive site or one protected reactive site which can be rendered reactive for conjugation, and each of said subunits having at least three thioether moieties, the thioether ligand, its production, and the use of the complex for PCR, labelling, fluorescence quenching and identification. Moreover the the complex can be used for the labelling of molecules, especially biomolecules such as peptides, proteins, oligonucleotides and nucleic acids, lipids, sacharides and oligosacharides as well as mixed forms of the latter such as glycopeptides, glycoproteins, lipopeptides, lipoproteins, as well as functional mimics of the latter such as PNA, pRNA, threose nucleic acids, stereoisomeric peptides and nucleic acids including spiegelmers (enantiomeric forms of RNA and DNA), but also synthetic polymers, block-copolymers and dendrimers, natural products not listed above such as steroids, terpenes, alkaloids, antibiotics, vitamins, and others as well as non-natural chemicals and applications of the conjugates for imaging (TEM, STM, AFM), cytostaining, histology, immunostaining, silver staining of gels and other materials, electrochemical detection of binding events on electronic chips, fluorescence quenching in molecular beacons for quantitative PCR, nanoscale antenna for the selective inductive heating of labelled molecules by electromagnetic radiation in the MHz to THz range, most preferable around 1 GHz, allowing to control the behaviour of labelled species in the sense of a switching process e.g. based on the melting of supramolecular or non-covalent aggregates including intramolecular switching processes, as well as applications as building blocks in nanotechnology such as the production of nanowires, nanocircles and nanocoils, including novel approaches in nanorobotics based on the noncovalent nanoscaffolding of functional modules.

### BACKGROUND OF THE INVENTION

The Schmid cluster complex (Schmid, G. et al., Chem. Ber., 114:3634 (1981)) Au₅₅(PPh₃)₁₂Cl₆ has stimulated many different areas of technology ranging from catalysis research (Haruta, M. et al., J. Catal., 144:175 (1993)) to the concept of quantum electronics (Volokitin, Y. et al., Nature 384:621-623 (1996)). Monofunctionalized, water soluble derivatives of the cluster complex (Hainfeld, J. F. and Furuya, F. R., J. Histochem. Cytochem., 40:177-184 (1992)) became commercially available and found numerous applications (Bendayan, M., Science, 291:1363-5 (2001)) e.g. as antibody- and peptide conjugates for TEM imaging that enabled recent discoveries in neurobiology (Bergles, D. E. et al., Nature, 405:187-190 (2000); Nusser, Z., Nature, 395:172-177 (1998); Segond von Banchet, G. and Heppelman, B., J. Histochem. Cytochem., 43, 821 (1995); Malecki, M. et al., Proc. Natl. Acad. Sci. USA, 99:213-218 (2002); Shigemoto, R. et al., Nature, 381:523-525 (1996)). Oligonucleotide conjugates of these cluster complexes contributed to the design of nanocrystal arrays (Mirkin, C. A. et al., Nature, 382: 607-609 (1996); Alivisatos, A. P. et al., Nature 382:609-611 (1996); Niemeyer, C. M., Angew. Chem. Int. Ed. Engl., 40:4128-4158 (2001)). Recently, gold clusters were introduced as universal fluorescence quenchers in molecular beacons (Dubertret, B. et al., Nature Biotech., 19:365-370 (2001)) and as nanoscale antenna for GHz radio frequency radiation whose receival causes local and selective inductive heating of cluster-labelled biomolecules (Hamad-Schifferli, K., Nature, 415:152-155 (2002).

These articles as well as current experiments in DNA nanoscale robotics (Dorenbeck, A. et al., submitted; Eckard, L. et al., submitted) point to the need for an increased thermostability of gold cluster labels, in particular of water-soluble golg cluster complexes, which can be used as monolabels by carrying a single functional group that allows monoconjugation, which are thermostable as well as chemically stable because of a suitable ligand shell, and which are uniform in particle size due to the fact that the size of the ligand shell matches the geometric and electronic requirements of the cluster core. Possible future applications of such clusters in nanotechnology and medicine also call for a rational and tailored synthesis of ligands that allow to shield the cluster core in a defined, viz non-statistical mode of complexing thereby allowing to prepare larger quantities of the materials at an increased level of cost-efficiency.

It is known that the replacement of the monopodant triphenylphosphane ligands in such clusters against suitable functionalised tripodal thioethers based on 1,3,5-trismercaptomethylbenzene scaffolds results in gold clusters with improved stability and water solubility (Pankau, W. M. et al., Chem. Commun., 519-520 (2001)).

The problem posed in view of the above state of the art therefore is to find a ligand for metal clusters, in particular gold clusters, which form complexes with said metal clusters and which render said complexes thermally stable up to 100° C., in particular stable under the temperature changes of the polymerase chain reaction. Further, said cluster complexes should be water soluble and have a site reactive for coupling to form conjugates with a biomolecule or any other molecule.

### SUMMARY OF THE INVENTION

The concept behind the ligand of the present invention is sketched in FIG. 1. The metal cluster core, here an Au₅₅ cluster core may be described as a cuboctahedron whose surface is composed of eight edge connected triangles (111) and six squares (110). As such, Au₅₅ is expected to bind four tripodal ligands if the binding mode of the ligands is comparable to the Schmid cluster where the 12 triphenylphosphanes most likely occupy the edges of the cuboctahedron. It was now found that if the four triangles are connected by suitable linkers, a dodekadentate monoligand results which provides for an increased stability of the complex compared to the four single tripodal ligands. Moreover it was found that by a specific synthesis it is possible to establish a the final material that carries a single functional moiety ready for bioconjugation. Moreover, the functional groups of the ligand are selected so as to render the complex sufficiently water soluble.

Therefore, the present invention provides a new generation of biocompatible gold clusters that are captured by a single, dodekadentate, thioether-based, nanoscale “grip”. Moreover, the present invention demonstrates that “gripped” clusters in oligonucleotide conjugates survive the temperature conditions of PCR and hybridisation experiments. In particular, the present invention relates to
(1) a conjugatable metal cluster complex comprising
   (a) a metal cluster of type Mₖ, and
   (b) a multivalent thioether ligand comprising at least two ligand subunits and having one reactive site or one protected reactive site which can be rendered reactive for conjugation, and each of said subunits having at least three thioether moieties;
(2) in a preferred embodiment of the invention on the cluster as defined in (1) above the ligand has the linear structure (I)
   (BₘAB′ₙ)ₚ(BₘAB′ₙ)(BₘAB′ₙ)_{q} (I)
or the cyclic structure (II). 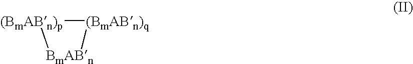
or the dendrimeric structure (III) 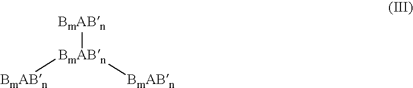
   wherein (BₘAB′ₙ) corresponds to one subunit, wherein
   (i) A is a core structure selected from substituted or unsubstituted aryl, heteroaryl, cycloalkane or heterocycloalkane residue, or a carbon atom, nitrogen atom, preferably said core structure has C₃ symmetry and more preferable is a substituted or unsubstituted benzene residue, even more preferable the core structure has attached thereto the at least three thioether moieties and/or linear or branched alkyl moieties being directly or through the thioether attached to the core structure;
   (ii) B and B′ are substituted by one or more first functional groups selected from —COOH, —COOR′, —OP(O)(OH)₂, —OP(O)(OH)OR′, —OP(O)(OR′)₂, —SH, —SO₂R′, —SO₃H, and —SO₃R′ (where R′ is a protecting or leaving group);
   (iii) B′is further substituted by at least one second functional group which is selected from —OH, —SH, —NH₂ and a protected form thereof, and preferably is —NH₂ or a protected —NH₂ group, whereby said second functional group of one B′ of the ligand forms the reactive site or protected reactive site which can be rendered reactive for conjugation;
   (iv) m, n, p, q are integers each ranging independently from 0 to 25, preferably from 0 to 10, whereby in case of the linear structure (I) m+n≧3 and p+q≧1 and in case of the cyclic structure (II) m+n≧3 and p+q≧2, preferably in any case m+n=3 and p+q=3; and/or
   (v) at least two subunits are bonded to each other through a covalent B-B′ linkage which is achieved by reaction of the first functional group of B with the second functional group of B′;
(3) in an even more preferred embodiment of the invention, subunit as defined in (2) above corresponds to the formula (IV) 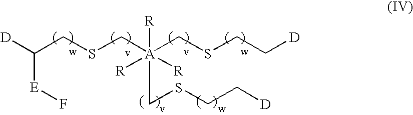
   wherein,
   (i) A is the core structure as defined in (2) above, preferably is a 1,3,5 trisubstituted benzene optionally having 1 to 3 additional substituents R;
   (ii) R is independently selected from H or lower alkyl, preferably any of H, —CH₃, —C₂H₅, halogen;
   (iii) D is the first functional group as defined in (2) above; and
   (iv) E is the second functional group as defined in (2) above; and
   (v) F is H or a protecting group and for one subunit of the ligand F is H or a protecting group or a functional group or a moiety which can be rendered functional selected from —NH₂, —CHO, —OH, -Halogen, —SH, and —SS so that the E-F moiety forms the reactive site or protected reactive site which can be rendered reactive for conjugation; and/or
   (vi) v and w are integers each ranging independently from 0 to 10, preferably is 1;
(4) a most preferred embodiment of the invention as defined in (1) to (3) above, the ligand has the structure of formula (VI): 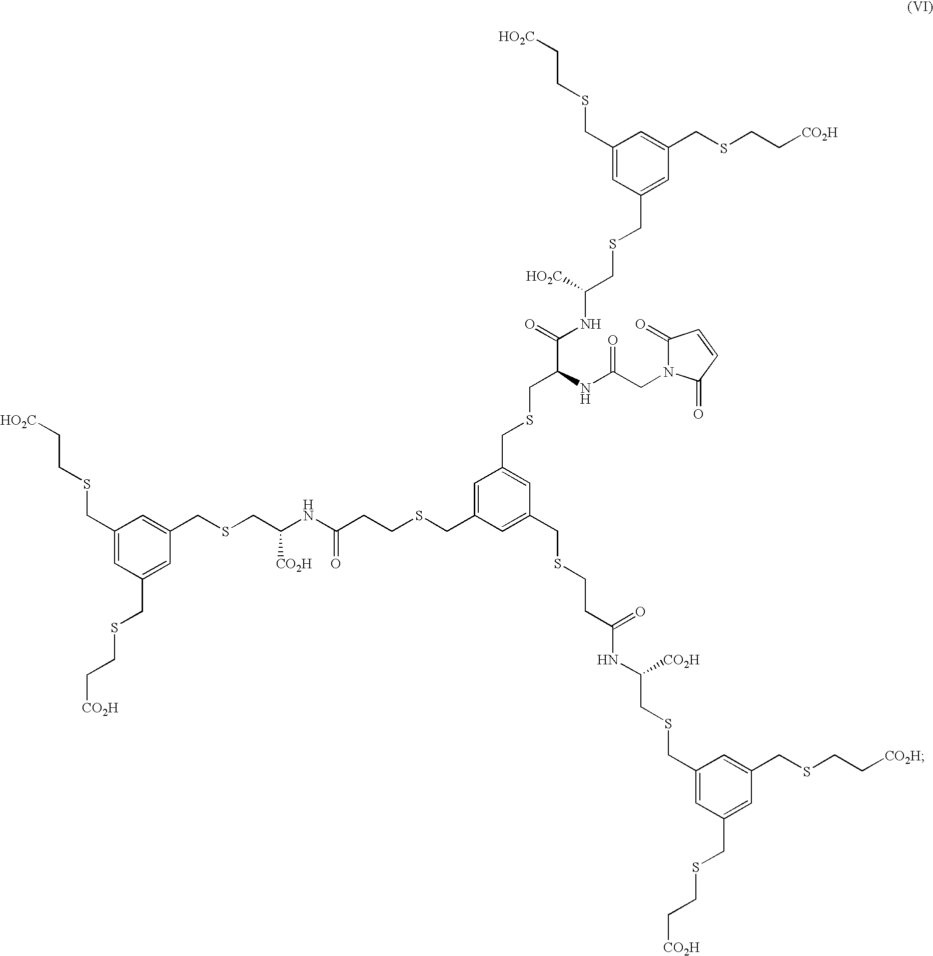
(5) the ligand as defined in (1) to (4) above or the subunit as defined in (3) above;
(6) a method for preparing the ligand as defined in (3) or (4) above, which method comprises the following steps of
   (i) preparing the subunits as defined in (3) above; and
   (ii) coupling together at least two subunits obtained in step (i), whereby one of the subunits coupled together has a reactive site or protected reactive site which can be rendered reactive for conjugation; and
   (iii) optionally deprotection;
(7) the use of the complex as defined in (1) to (4) above in a polymerase chain reaction (PCR), for labelling of a carbohydrate, peptide, nucleotide, peptide-nucleotide-adduct (PNA), polyether, for quenching the fluorescence of one or more fluorescence labels, for the identification of a nucleotide, peptide-nucleotide-adduct (PNA) or oligonucleotide, as TEM-Labels, for immunostaining, for silver staining, etc.

### DESCRIPTION OF THE FIGURES

FIG. 1 General concept of a gold cluster grip. Four tripodal binders employing thioethers of 1,3,5-trismercaptomethylbenzene scaffolds occupy four (111) faces of the cuboctahedral cluster. The triangles are linked (bold lines) to result in a dodekadentate monoligand carrying a functional group F that allows biomolecule monoconjugation.

FIG. 2 Structure and synthesis of the dodekadentate grip 8 carrying a monomaleimido moiety.

FIG. 3 Chemical and physical processes underlying the determination of cluster stability in a cluster torturing experiment. Cluster torturing involves cycles of heating and cooling while measuring the fluorescence of a 3′-fluoresceine labelled oligonucleotide in the presence of the 5′-gold labelled complement.

FIG. 3b Fluorescence readout during 100 cycles of torturing a solution of 1 μM 5′-ATTCCCGGTT ATGTCCAATG GGTGCAT-3′-FAM, 3 μM 5′-(6-mercapto-hexylphosphate)-modified 5′-ATGCACCCAT TGGACATAAC CGGGAAT conjugated with a mixture of gold-filled and unfilled grips 8, 300 mM NaCl, 100 mM MOPS, pH 7.5.

FIG. 4 Structure and synthesis of the dodekadentate grip 18 carrying a monomaleimido moiety.

FIGS. 5-6 Structure and synthesis of the dodekadentate grips 19 and 20 carrying p-formyl benzoic acid moieties.

FIG. 7 Structure and synthesis of the grip 26.

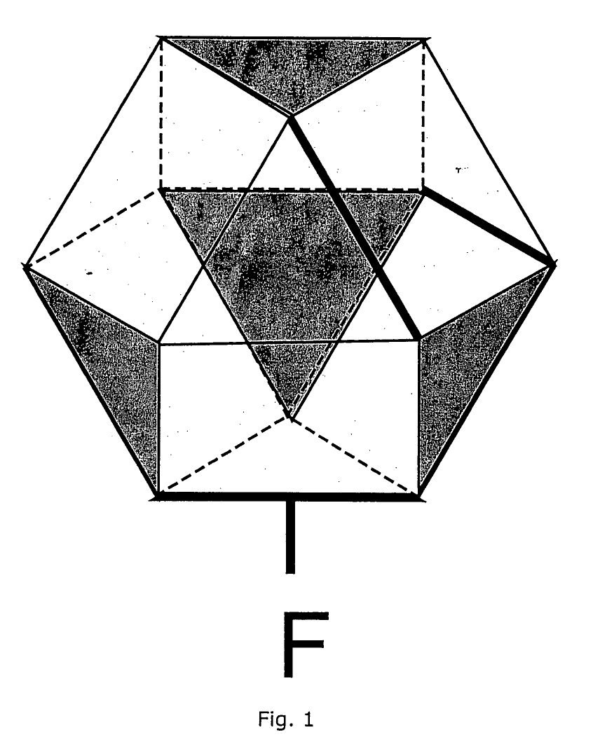

### DETAILED DESCRIPTION OF THE INVENTION

The conjugatable metal cluster complex of the embodiment (1) of the present invention comprises a metal cluster of type Mₖ, and a multivalent thioether ligand (hereinafter shortly referred to as “ligand”).

It is preferred that the metal cluster Mₖ is a cluster wherein M is selected from one or more transition metals, heavy main group metals, etc. Particularly preferred metals are noble metals such as Pt, Pd, Ag, Au, etc., including Hg. The most preferred metal is Au. k is preferably an integer ranging from about 10 to about 600, and is most preferably about 55. The most preferred metal cluster is Au₅₅.

As indicated above, the multivalent ligand comprises at least two ligand subunits and has one reactive site or one protected reactive site which can be rendered reactive for conjugation, and each of said subunits has at least three thioether moieties. It is, however, preferred that the ligand comprises at least three, preferably at least four ligand subunits.

Suitable reactive sites and the protective groups for said reactive sites are to be determined by the skilled person (e.g. according to T. W. Greene, Protective Groups in Organic Synthesis, John Wiley & Sons (1981)), which is herewith incorporated by reference in its entirety) so that they do not interfere with other functionalities of the ligand. Such reactive sites or protected reactive sites which can be rendered reactive for direct conjugation include —NH₂, —OH, —SH, -halogen, etc. (among which —NH₂ is preferred); or for modification and transformation into a monoconjugatable moiety include an aldehyde, an active ester, a thioester, a hydrazide, a semicarbazide, a phosphoramidite, a vinylsulfone, a isocyanate, a isothiocyanate, a reactive disulfide, etc. (among which a maleimide is preferred); or for transformation into a polymerizable moiety include an acrylamide, bis- or trisvariants of the moieties listed above, etc.

The subunit of the ligand may be connected through a linkage including, but not limited to, —C(O)O—, —C(O)S—, —C(S)O—, —C(S)S—, —C(O)NH—, —S(O)₂O—, —S(O)₂S—, —S(O)₂NH—, —O—, —S—, —S—S—, —C—C—, —C═C—, —C═N— or —C═N—NH— or the like. Preferably a —C(O)NH— moiety is utilized to connect the subunits. According to the invention, the subunits may be connected in a linear, cyclic or dendrimeric manner. It is, however, preferred that the subunit has C₃ symmetry.

In another preferred embodiment of the invention the ligand is in a protected form and attached as a side chain to a suitable protected amino acid (such as a N-Boc or a N-Fmoc amino acid) that allow to synthesize peptide conjugates of the grip ligand or oligomers of the grip ligand or combinations of the latter units using standard peptide synthesis protocols and a postsynthetic formation of monomeric or oligomeric gold clusters after deprotection.

Embodiments (2) and (3) of the invention specified in the passage “Summary of the Invention” provide particularly preferred thioether ligands and subunits. It is however to be noted that the definitions given in said passage are not to be construed as to limit the invention.

Particularly preferred subunits (among those defined in (3) above) are that where the variables within the structure of formula (IV) are as follows:
A is a benzene residue; R is hydrogen or methyl; D is COOH; E is —NH₂; F is H; one subunit of the ligand F is a moiety of formula (V) 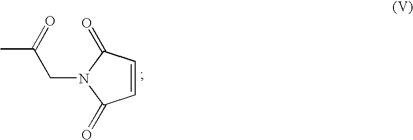
   or an ω-aminocarboxylic acid or an α,ω-diaminocarboxylic analogue of the moiety of formula (V), or any other NH₂ protecting group defined hereinbefore, or E-F represents any other protected functional group defined hereinbefore; v=1 and w=1; and/or p=0.1 and q=2.

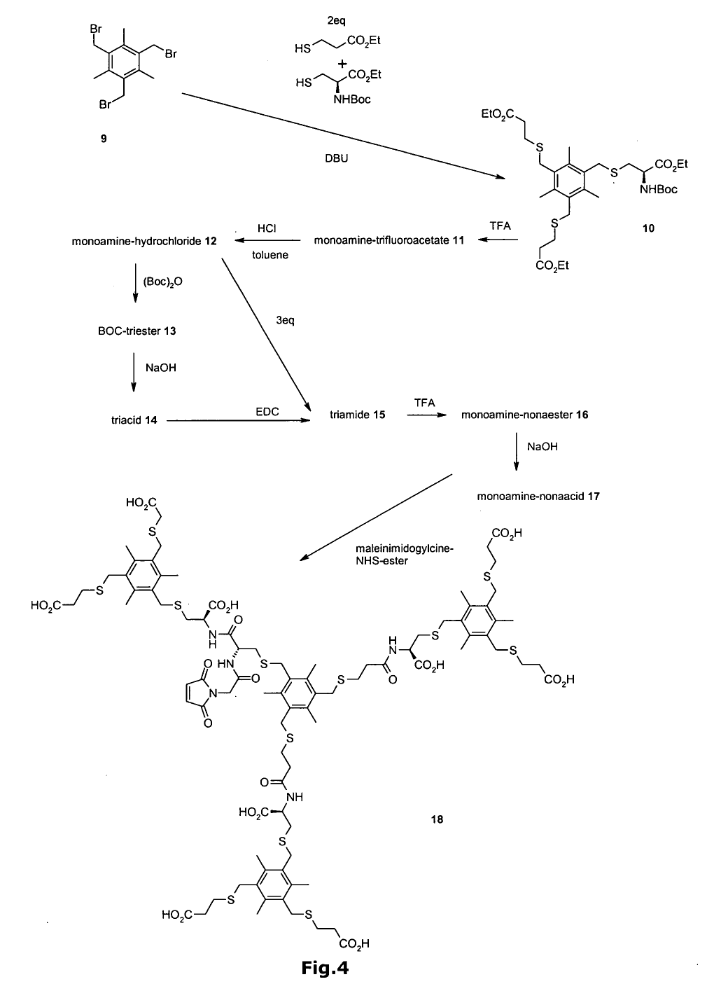

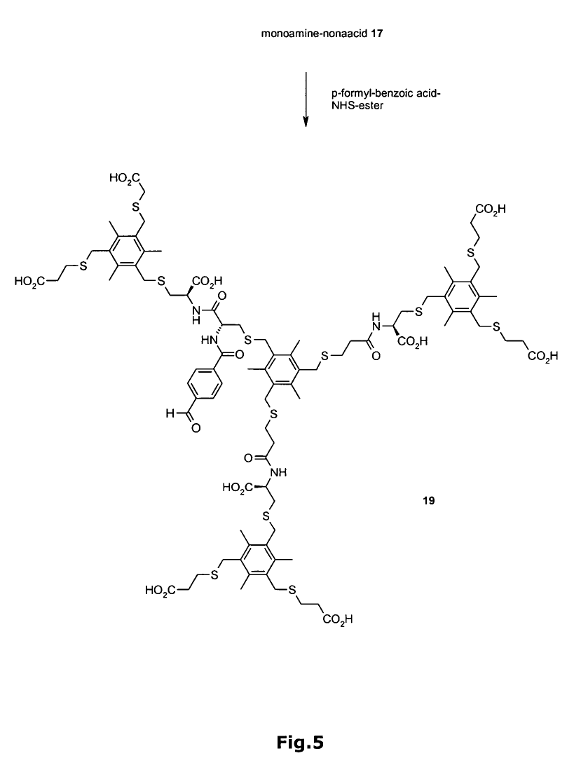

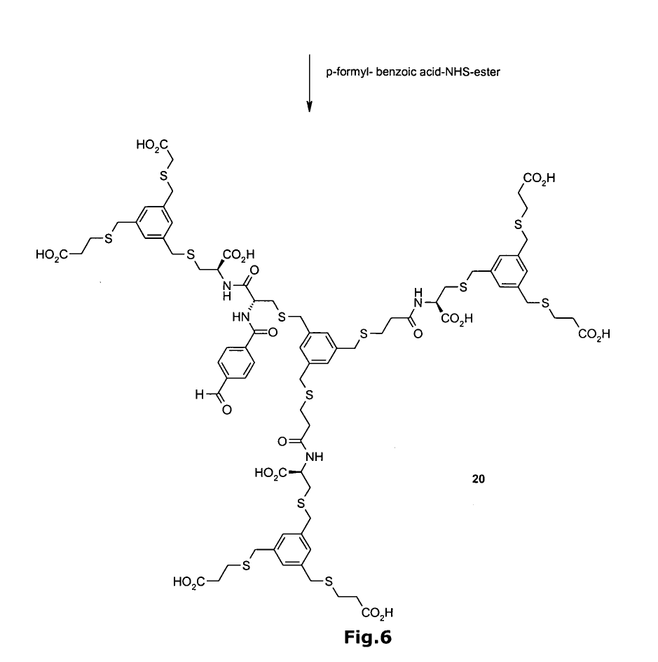

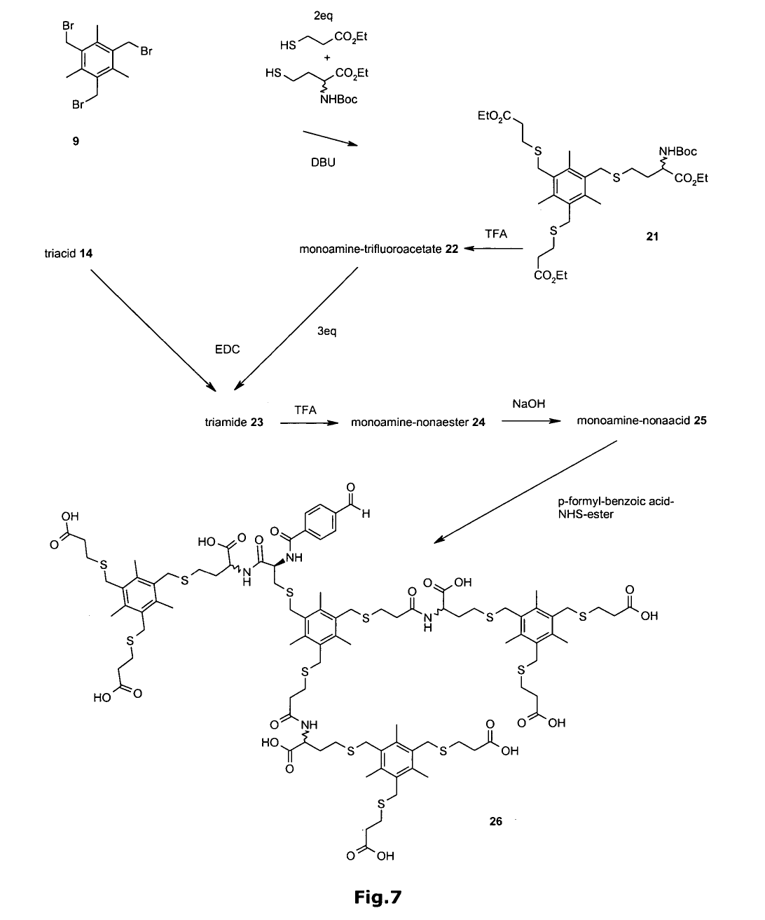

In a most preferred embodiment the above defined specific subunits are connected in a dendrimeric manner. Specifically preferred ligands are that of formula (IV), and grids 18, 19, 20 and 26 shown in FIGS. 4-6.

In the complex of the invention any the ligand may have a subunit additionally comprising a first carbohydrate, peptide, nucleotide, peptide-nucleic acid (PNA), p-RNA, polyether, or the like. Preferably an oligonucleotide is attached to the reactive site through a covalent bond.

The method for preparing the ligand of embodiment (6) of the invention may further comprises the steps of
(i) reacting a compound of formula (VII) 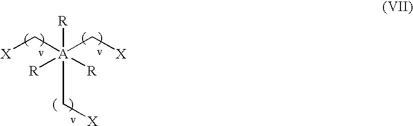
wherein
   A, R, and v are as defined hereinbefore, and X is a leaving group, with the compounds of formula (VIII) and (IX) separately or with a mixture of the compounds of formula (VIII) and (IX), 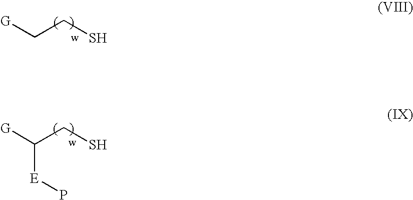
   wherein w and E are as defined hereinbefore, G is —COOH, —COOR′, —OP(O)(OH)₂, —OP(O)(OH)OR′, —OP(O)(OR′)₂, —SH, —SO₂R′, —SO₃H, —SO₃R′ (where R′ is a protecting or leaving group), and P is a protecting group to obtain the compound of formula (X) 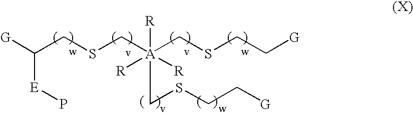
   wherein A, R, E, G, P, v, and w are as defined above; and
(ii) reacting the compound of formula (X) with a suitable base or acid to obtain the compound of formula (XI) 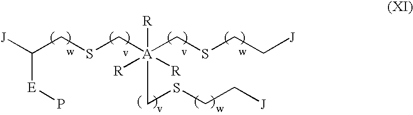
wherein A, R, E, P, v, and w are as defined above and J is selected from any of —COOH, —OP(O)(OH)OR′, —SH, and —SO₃H; and
(iii) reacting the compound of formula (X) with a suitable base or acid to obtain the compound of formula (XII) 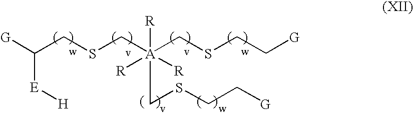
wherein A, R, E, G, v, and w are as defined above; and
(iv) reacting the compound of formula (XI) with the compound of formula (XII), preferably in a molar ratio of (XI):(XII)≧1:3, and in the presence of one or more suitable activating reagents; and
(v) reacting the compound obtained in step (iv) with a reagent suitable to remove the protecting group P; and
(vi) reacting the compound obtained in step (v) with a suitable base or acid to convert all G-groups to J-groups whereby the G- and J-groups are as defined above; and
(vii) optionally reacting the free E-H group of the compound obtained in step (vi) with a reagent of formula F—Y or F—H, whereby F is as defined above but not H and Y is a suitable leaving group, and, in case F—H is employed, in the presence of a suitable water removing agent, to obtain the ligand as defined in (3) above, or a compound, wherein J is different from D as defined in (3) above; and
(viii) in case for the compound obtained in step (vii) J is different from D as defined in claim 4, all J-groups of said compound are converted to D-groups to obtain the ligand as defined in (3) above.

The present invention also pertains to a method for preparing the subunit as defined in (3) above, which method comprises steps (i) and (ii) or steps (i) and (iii) as defined hereinbefore.

Finally the invention provides a method for preparing the complex as defined in (1) above, which comprises reacting the ligand with the metal cluster. Said method may further comprise one or more of the following steps: reduction of a precursor for the metal cluster, preferably HAuCl₄; and manipulation of conjugates by inductive heating using radio frequency in the presence of the ligand thus forming the cluster.

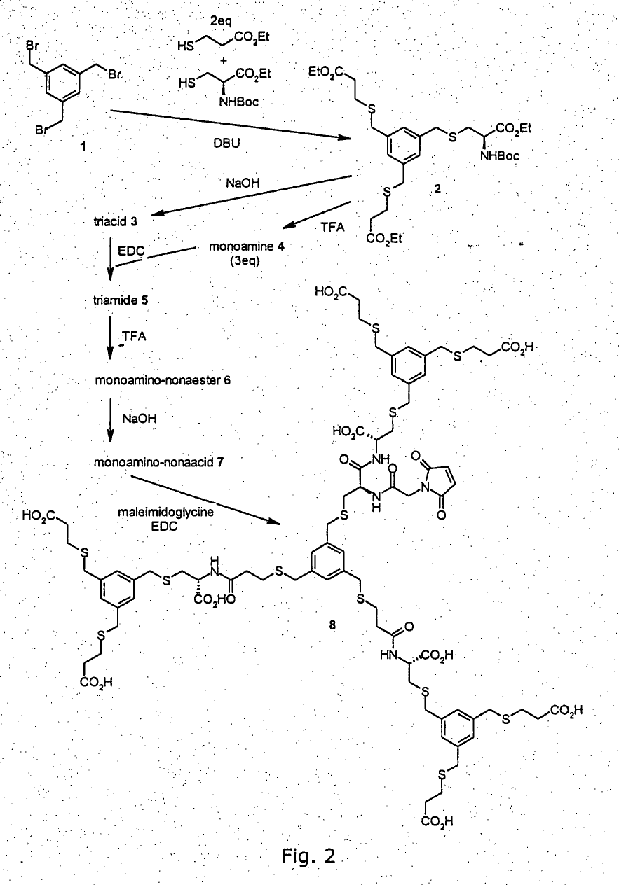

The method for preparing the ligand of embodiment (6) of the invention is hereinafter explained in more detail with reference to the target ligand 8 together with a sketch of its synthesis is shown in FIG. 2 (which is, however, not to be construed as to limit the invention). The inventors of the present invention selected a monomaleimido moiety as the monoconjugable unit in order to gain functional comparability with the commercially available variant of the Schmid-cluster. Starting from trisbromide 1, trithioether 2 was generated as a key percursor that allowed to synthesize 8 on a divergent-convergent route. Ligand 8 was converted into its gold cluster by phase transfer synthesis as previously described for tris-thioethers having a structural skeleton similar to that of 2. The cluster revealed a uniform size distribution with an average diameter of 1.4 nm in high resolution TEM. The cluster was conjugated with a 5′-thiol modified 27-mer oligonucleotide, whose complement was synthesized in its 3′-fluoresceine labelled form.

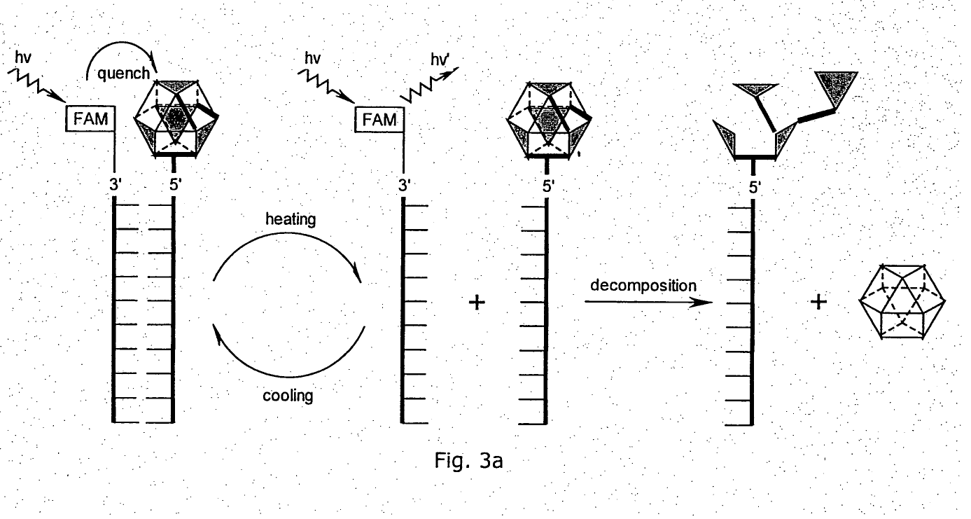

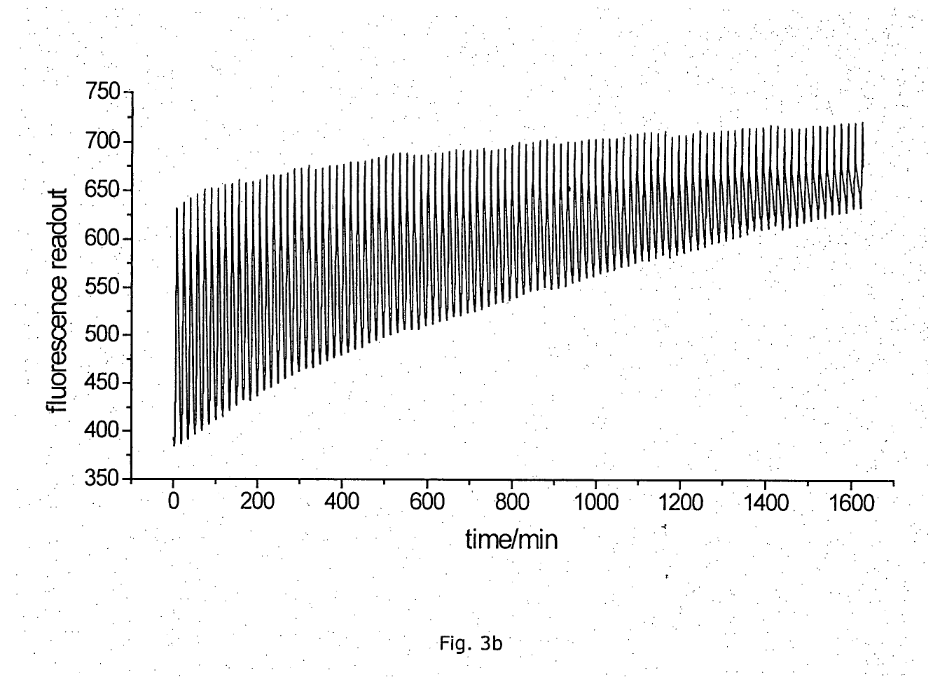

For the study of thermostability of the label a “cluster torturing” experiment was performed, in which the fluorescence signal from a mixture of both oligonucleotides was monitored during 100 cycles of temperature variation. Each cycle consisted of a heating period from 20° C. to 95° C. with 10 K/min, a “torture” period for 6 min at 95° C. and a recooling period with 20 K/min giving an average temperature of 70.5° C. The rationale of temperature cycling is depicted in FIG. 3a. At low temperatures the duplex holds the gold cluster and the fluorescent dye within spatial proximity. Quenching of fluorescence takes place resulting in a low fluorescence readout. At high temperatures the fluorescent oligonucleotide exists in its single-stranded form giving an increase of the fluorescence signal due to the loss of its neighbouring quench. If the gold cluster escapes its grip during a cycle, or, if the latter's conjugation with the complement strand breaks, there will be no quench in the next cycle. Thus, kinetic information on the stability of clusters and/or their grip conjugation can be derived from the low-temperature fluorescence increase as a function of the cycle number relating to the torturing time. FIG. 3b depicts how the temperature-driven fluorescence oscillations develop as a function of the time. From a comparison of experiments involving the empty and the filled grip we conclude that not the grip itself but the gold cluster inside is the reason for the quench, as to be expected for the UV absorption properties of the grip. Moreover, the “baseline” fluorescence of both, the duplex and the single strand, decrease with the temperature in each cycle, the latter however at a higher level of fluorescence intensity due to a poorer stacking of the 3′-fluoresceine to the single strand. Different baseline courses for single and double-stranded species also explain why a slight increase of fluorescence is observed for the duplex with empty grip at the melting transition.

Any conceivable approach in DNA bio- and nanotechnology, where the remarkable properties of gold clusters are to be employed will call for label compatibility with at least the basic procedures of molecular biology. To the best of the inventors' knowledge the gripped cluster presented here is the first example that an Au₅₅ monolabel survives the temperature conditions of PCR and hybridisation protocols. A typical PCR-experiment may be equivalent to perhaps 100 min of the “torturing” described in the present invention, if one recalls that the exposure to a temperature of 95° C. needs 1 min or less in PCR while each of the “torturing” cycles employed 6 min at 95° C. The average temperature in the “torturing” experiment (see example 10) is close to PCR, so that one cycle in said experiment may be compared to 4-6 typical PCR-cycles. From FIG. 3b it is evident, that only a small fraction (less than 10%) of gold nanocrystals did not survive during the first 100 min of treatment. Needless to say that the full potential of universal quenching (e.g. quantitative PCR of gene sets employing beacon sets with different dyes in the same tube) and radio frequency induced single-molecule heating (e.g. for nanoscale robotics) can only launch from a thermostable ground.

The invention is further explained by the following examples which are, however not to be construed to limit the invention.

### EXAMPLES

Acronyms:

δ chemical shift (in ppm)
DBU 1,8-diazabicyclo[5.4.0]undec-7-ene
EDC 1-(3-dimethylaminopropyl)-3-ethylcarbodiimide hydrochloride
TFA trifluoroacetic acid
pRNA Pyranolsyl RNA
AFM Atomic Force Microscopy
STM Scanning Tunnel Microscopy
PCR Polymerase Chain Reaction
DBU 1,8-Diazabicyclo[5.4.0]-7-undecen
TEA Triethylamine
HOBT Hydroxybenzotriazole
MOPS Morpholinopropiosulfonic acid

### Example 1

### Synthesis of N-Butyloxycarbonyl-S-(3,5-bisethoxycarbonylethylthiomethylbenzyl)-cysteine 2

3.83 g (28.53 mmol) 3-mercaptopropionic acid ethyl ester, 3.57 g (14.27 mmol) N-tert-butyloxycarbonyl-L-cysteine ethyl ester and 6.51 g (42.80 mmol) DBU were dissolved in 100 ml toluene and the solution was added dropwise over a period of 2 h to a solution of 4.63 g (12.97 mmol) tris-bromomethyl-benzol 1 in 50 ml toluene. The mixture was stirred for 2 h at ambient temperature. The precipitate was separated by filtration and washed with toluene. Excess DBU was removed by extraction with 50 ml of hydrochloric acid (5%). The toluene layer was successively washed with 50 ml of sat. NaHCO₃ and NaCl, dried over MgSO₄ and evaporated to give 9.58 g of crude material. Product 2 was isolated in 480% yield by chromatography on 750 g silica using cyclohexane/ethyl acetate=6:1 (v/v) as eluent. ¹H-NMR (200 MHz, CDCl₃): δ=1.26 (m, 9H), 1.46 (s, 9H), 2.61 (m, 8H), 2.68 (m, 2H), 3.70 (s, 6H), 4.16 (m, 6H), 4.48 (br. m, 1H), 5.33 (br. d, 1H), 7.15 ppm (s 3H). ¹³C-NMR (50 MHz, CDCl₃): δ=14.31, 26.52, 28.45, 33.98, 34.61, 36.18, 36.58, 53.35, 60.67, 61.81, 80.19, 128.34, 138.56, 138.98, 155.28, 171.18, 171.93 ppm. MS (MALDI-TOF) m/e=656.32 (M⁺+Na).

### Example 2

### Synthesis of N-Butyloxycarbonyl-S-(3,5-biscarboxyethylthiomethylbenzyl)-cysteine 3

566 mg (0.90 mmol) 2 were dissolved in 30 ml warm ethanol combined with 20 ml 1N NaOH and stirred for 2 h at ambient temperature. The pH was adjusted to 4-5 with approx. 20 ml 1N HCl and a little amount of aq. sodium bicarbonate. The organic solvent was removed by evaporation at reduced pressure and the resulting mixture was cooled to 0° C., acidified (to pH 1) with dilute HCl until no more precipitate was formed, and extracted three times with 25 ml dichloromethane each. The combined extracts were washed with NaCl and dried over MgSO₄. Evaporation of the solvent and drying in vacuo yielded 400 mg (81%) of a colourless, hygroscopic foam. ¹H-NMR (200 MHz, CDCl₃): δ=1.43 (s, 9H), 2.55 (d, 4H), 2.62 (d, 4H), 2.58 (dd, 2H), 3.70 (s, 6H), 4.50 (br, 1H), 5.44 (m, 1H), 7.16 (s, 3H), 9.94 ppm (br, 3H). ¹³C-NMR (50 MHz, CDCl₃) δ 26.01, 28.46, 33.31, 34.55, 36.25, 53.00, 80.89, 128.51, 138.52, 139.09, 155.81, 175.76, 177.42 ppm. MS (FAB): m/e 548 (M⁺), 570 (M⁺+Na).

### Example 3

### Synthesis of S-(3,5-Bisethoxycarbonylethylthiomethyl-benzyl)-cysteine 4

A stirred solution of 1.80 g (2.85 mmol) 2 in 20 ml dichloromethane to which 20 ml TFA was added dropwise, was kept for 1 h at 0° C. and 1 h at ambient temperature. Dichloromethane was evaporated in vacuo and TFA was removed by subsequent coevaporation with six 30 ml portions of chloroform. The product (1.84 g, 99%) was pure enough for further synthetic transformations. ¹H-NMR (400 MHz, CDCl₃): δ=1.25 (t, 6H), 1.29 (t, 3H), 2.54 (t, 4H), 2.66 (t, 4H), 3.05 (d, 2H), 3.69 (s, 4H), 3.74 (s, 2H), 4.10 (m, 5H), 4.15 (q, 2H), 7.15 (s, 2H), 7.20 (s, 1H), 7.67 ppm (br, 3H). ¹³C-NMR (100 MHz, CDCl₃): δ=13.95, 14.19, 26.52, 31.62, 34.62, 36.16, 36.46, 52.69, 61.15, 63.62, 52.69, 61.15, 63.62, 128.31, 128.85, 137.77, 139.62, 167.68, 172.61 ppm. MS (FAB): m/e 532 (M⁺).

### Example 4

### Synthesis of Triamide 5

A suspension of 969 mg (1.50 mmol) 4, 605 mg (6.00 mmol) TEA and 270 mg (2.00 mmol) HOBT in 10 ml absolute trichloromethane was added while stirring to a solution of 274 mg (0.50 mmol) 3 in 10 ml absolute CDCl₃. Stirring was continued until complete dissolution of the all solids. The reaction was started by the addition of 720 mg (3.75 mmol) EDC and allowed to proceed while stirring for 16 h at ambient temperature under a dry atmosphere (argon). The mixture was diluted with 100 ml trichloromethane, washed with 20 ml portions of 1 N HCl, sat. NaHCO₃ and sat. NaCl, dried over MgSO₄, and evaporated to give 1.32 g of crude product, from which 5 was isolated by flash-chromatography on 100 g silica eluting with cyclohexane/ethyl acetate 1:1 (v/v). Yield: 546 mg (52%). ¹³C-NMR (50 MHz, CDCl₃): δ=14.36, 21.15, 26.65, 27.06, 27.18, 28.53, 33.11, 34.19, 34.71, 36.27, 51.90, 60.50, 60.81, 61.99, 128.35, 138.57, 139.04, 170.96, 171.15, 171.97 ppm. MS (MALDI-TOF): m/e 2114.63 (M⁺+Na).

### Example 5

### Synthesis of Monoamino Nonaester 6

600 mg (0.29 mmol) of 5 were dissolved in 20 ml dichloromethane and treated with 20 ml TFA as described for 4. After work up the product (605 mg, 100%) had sufficient purity for the next synthetic step. ¹³C-NMR (50 MHz, CDCl₃): δ=14.15, 14.27, 26.54, 33.79, 34.23, 34.65, 36.15, 52.16, 61.02, 62.35, 89.70, 128.29, 128.47, 138.24, 138.38, 139.07, 139.66, 169.93, 170.64, 172.38 ppm.

### Example 6

### Synthesis of Monoamino Nonaacid 7

546 mg (0.26 mmol) 6 were dissolved in 20 ml warm ethanol during sonification for 15 min. 20 ml of aq. NaOH (10%) were added and the resulting mixture was stirred for 1 h at ambient temperature. The alcohol was removed by evaporation. 1N HCl was added dropwise to the remaining, vigorously stirred suspension until pH 2 was reached. The precipitate was isolated by centrifugation, washed several times with distilled water and dried in vacuo over KOH for a period of 16 h to give 286 mg (63%) of the product as an colourless powder. MS (MALDI-TOF): m/e 1736.07 (M⁺).

### Example 7

### Synthesis of Grip 8

17 mg (10 μmol) 7 and 25 mg (100 μmol) maleimidoglycine-NHS-ester were dissolved in 2 ml DMF and stirred for 27 h at 60° C. After cooling to room temperature, 20 ml of diethyl ether was added to precipitate the product, which was obtained quantitatively after centrifugation, washing with two 8 ml portions of diethyl ether and drying in a speedvac concentrator. MS (MALDI-TOF): m/e 1875.41 (M⁺), 1897.41 (M⁺+Na), 1920.16 (M⁺+2Na).

### Example 8

### Phase Transfer Synthesis of Gripped Gold Clusters

A solution of 14 mg (1 μmol) of Au₅₅(PPh₃)₁₂Cl₆ in 10 ml dichloromethane was vigorously stirred for 16 h with an overlaying solution of 3.6 mg (2 μmol) of 8 in 10 ml 0.1 M potassium phosphate buffer, pH 7.0. The phases were separated by short centrifugation and the aqueous layer was aliquotated into Eppendorf tubes and evaporated using a speed vac concentrator.

### Example 9

### Preparation of Oligonucleotide Conjugates

A 5′—SH modified 27mer oligonucleotide, sequence 5′-ATGCACCCAT TGGACATAAC CGGGAAT was reacted with a tenfold excess of gripped clusters in accordance to a previously established procedure developed for a commercially available monomaleimido derivative of the Schmid cluster. The reaction took place for 2 h at room temperature under an argon atmosphere.

### Example 10

### Torturing Experiments

The experiments were performed with the raw material from the previous protocols, meaning that a maximum of 50% of the grip conjugates can be filled with gold nanocrystals, and consequently, that the quench of fluoresceine at low temperatures can only reach a maximum of 50% of its theoretical value. The experiments were performed on a Varian Eclipse equipped with a temperature profiling control and a magnetic cuvette stirrer.

### Example 11

### Synthesis of N-Butoxycarbonyl-S-(3,5-bisethoxycarbonyl-ethylthio-methymesityl)-cysteine in the statistical mixture 10

91.3 g 1,3,5-Trisbromomethylmesitylene 9 (0.23 mol) were dissolved in 1.8 l toluene and a mixture of 62.7 g (0.25 mol) N-tert-butoxycarbonyl-L-cysteine ethyl ester, 67.5 g mercaptopropionic acid ethyl ester (0.5 mol) and 115 g DBU (0.75 mol), in 900 ml toluene, were added dropwise over a period of 45 min. The mixture was stirred for another 1 h at ambient temperature. 500 ml of 1N hydrochloric acid were added to solute the precipitate. The layers were separated and the organic layer was successively washed with each 500 ml hydrochloric acid (1N), NaOH (5%), sat. NaHCO₃, sat. NaCl, dried over MgSO₄ and evaporated to give 153 g (99%) of crude material, which was used in the next step without further analysis and purification.

### Example 12

### Synthesis of S-(3,5-Bisethoxycarbonyl-ethylthiomethy-mesityl)-cysteine trifluoroacetate in the statistical mixture 11

The crude product from example 11 was dissolved in 500 ml dichloromethane and cooled to 0° C. 500 ml trifluoro acetic acid were added dropwise over a period of 1 h. The solution was stirred for anther 1 h at ambient temperature. The solvent was removed by evaporation and the residue was five times with 50 ml chloroform each to remove the trifluoro acetic acid. This crude material was used in the next step without any further quantification, purification and analysis.

### Example 13

### Synthesis of S-(3,5-Bisethoxycarbonyl-ethylthiomethy-mesityl)-cysteine hydrochloride 12

The crude product from example 12 was dissolved in 180 ml warm toluene and 1.8 l of 0.6N hydrochloric acid were added. This 2-phase-system was stirred for 24 h at ambient temperature. After 15 min the first precipitate had formed. The suspension was put into a separatory funnel and 1.5 l of the aqueous layer were separated. The rest of the suspension was filtrated over a D3-glasfilter and the precipitate was washed two times with 100 ml toluene each. The crude product was dissolved in 200 ml boiling toluene and stirred for 2 h in an ice bath. To this thixotropic suspension another 100 ml cold toluene were added and the precipitate was isolated by filtration over a D3-glasfilter. The product was washed two times with 50 ml cold toluene each and dried in vacuum to give 31.4 g (22.5% with respect to the educt 9 in example 11) of the pure product 12, thus avoiding any chromatography during workup. 1H-NMR: (200 MHz, CDCl₃): 1.27 (t; 9H); 2.41 (s; 9H); 2.64 (t; 4H); 2.83 (m; 2H); 3.31 (br. s; 2H); 3.80 (s; 4H); 3.85 (s; 2H); 4.16 (q, 6H); 4.29 (m, 2H); 8.16 (br. s; 3H). ¹³C-NMR: (50 MHz, CDCl₃): 14.09/14.35; 15.94/16.08; 28.26; 32.67/33.41; 60.88; 63.32; 131.57/132.42; 135.74/135.96; 168.31; 172.18. MS (FAB): m/e 574 [M⁺−HCl].

### Example 14

### Synthesis of N-Butoxycarbonyl-S-(3,5-bisethoxycarbonyl-ethylthio-methymesityl)-cysteine 13

9.4 g (15,4 mmol) 12 were suspended in 100 ml dichloromethane and 2.35 ml TEA were added. After that a solution of 3.7 g (Boc)₂O was added. It was stirred for 4 h at ambient temperature. 200 ml water were added. After separation of the layers, the organic layer was successively washed with each 100 ml sat. NaHCO₃ and water, dried over MgSO₄ and evaporated. After drying in vacuum 10.2 g (98%) of pure product 13 were isolated. ¹H-NMR: (200 MHz, CDCl₃): 1.17 (m, 9H); 1.35 (s, 9H); 2.33 (s, 9H); 2.64 (m, 8H); 2.93 (m, 2H); 3.70 (s, 6H); 4.09 (m, 6H); 4.45 (br m, 1H); 5.30 (br d, 1H). ¹³C-NMR: (50 MHz in CDCl₃): 14.07/14.13; 15.7; 28.0; 28.2; 32.4/33.3; 9/35.5; 53.5; 60.5/61.5; 79.9; 131.9/132.2; 135.4/135.5; 155.0; 171.0/171.7. MS (FAB): m/e 696.1[M⁺ +Na]; 157.1.

### Example 15

### Synthesis of Triacid 14

8.0 g (11.9 mmol) 13 were dissolved in 210 ml ethanol and 140 ml aqueous NaOH (10%) were added. The solution was stirred for 2 h at ambient temperature. The alcohol was removed by evaporation and the pH 1 was adjusted by the addition of 6N hydrochloric acid. The precipitate was dissolved in 100 ml ethyl acetate and the aqueous layer was extracted with 100 ml ethyl acetate for another two times. The combined organic layers were washed with 100 ml water, dried over MgSO₄ and evaporated. By this route 5.63 g (80%) of the pure compound 14 could be isolated. ¹H-NMR: (200 MHz, DMSO): 1.40 (s, 9H); 2.38 (s, 9H); 2.60 (t, 6H); 2.76 (t, 6H); 3.80 (s, 6H); 4.21 (br d, 1H); 7.12 (br d, 1H); 12.37 (br s, 3H). ¹³C-NMR: (50 MHz, DMSO): 15.4; 27.7; 28.2; 31.6/31.7; 34.5; 53.5; 78.2; 131.9/132.1; 134.9/135.0; 155.4; 172.7/173.1. MS (FAB): m/e 612 [M⁺+Na]; 57 [—C₄H₉⁺].

### Example 16

### Synthesis of Triamide 15

1 g (1,7 mmol) triacid 14 and 2.84 ml (20,4 mmol) TEA were dissolved in 60 ml chloroform. 3.34 g (5.5 mmol) monoamine-hydrochloride 12 and 0.92 g (6.8 mmol) HOBT were dissolved in another 60 ml chloroform. After combining of the solutions the mixture was stirred for 15 min at ambient temperature. Then 2.44 g (12.7 mmol) EDC were added and the solution was stirred for anther 15 h at ambient temperature. After that time the solution was evaporated to dryness and 300 ml ethyl acetate were added to the residue. The residue could not be dissolved completely and 100 ml 1N hydrochloric acid were added. The mixture was centrifugated, which led to the accumulation of the product at the interphase between the two layers. The solvents were removed cautiously and the precipitate was successively washed with ethyl acetate and water. After drying in vacuo 1027 mg of the product were isolated.

The organic layer was successively washed with 100 ml each 1N hydrochloric acid, aqueous NaOH (5%), sat. NaHCO3, brine and dried over MgSO₄. After evaporation 2.45 g crude product were isolated. This was recrystallized from 50 ml ethyl acetate to give another 721 mg of the pure Triamide 15. So 1748 mg (46%) of the pure compound 15 could be isolated. ¹H-NMR: (200 MHz, CDCl₃): 1.27 (t; 27H); 1.45 (s; 9H); 2.42 (s; 36H); 2.5-3.2 (br.m; 12H); 3.78 (s; 24H); 4.16 (q; 18H); 4.38 (br.d; 1H); 4.85 (br.m; 3H); 5.46 (br.d; 1H); 6.54 (br.d; 3H). MS (ESI): m/e 2280 [M⁺+Na]; 2157 [M⁺−BOC].

### Example 17

### Synthesis of Monoamine-Nonaester 16

770 mg (0.34 mmol) Triamide 15 were dissolved in 30 ml dichloromethane and cooled to 0° C. 20 ml TFA were added and the solution was stirred for 1 h at 0° C. and for another hour at ambient temperature. The solvent and the acid were removed by evaporation and the residue was coevaporated for four times with 30 ml chloroform each. 900 mg (116%) of the product 16 in form of its trifluoroacetate were isolated. MS (ESI): m/e 2180 (100) [M⁺−TFA+Na].

### Example 18

### Syntheses of Monoamine-Nonaacid 17

770 mg Monaamine-nonaester 16 were dissolved in 60 ml warm ethanol. To this warm solution 30 ml aqueous NaOH (10%) were added and it was stirred for 2 h at ambient temperature. The solution was neutralized by the addition of 6N hydrochloric acid. After that the solution was concentrated to a final volume of 15 ml. The precipitate was dissolved by the addition of 50 ml 0.1 N NaOH and the product was precipitated by the dropwise addition of 6N hydrochloric acid. The product was isolated by centrifugation and was successively washed with 50 ml water and diethyl ether. After 2 d of drying in vacuum 560 mg (72%) monoamine-nonaacid 17 were isolated in form of its hydrochloride. MS (ESI): m/e 1904 [M⁺−HCl].

### Example 19

### Synthesis of Grip 18

19 mg (10 μmol) 17 and 25 mg (100 μmol) maleinimidoglycine-NHS-ester were dissolved in 2 ml dry DMF and stirred for 18 h at 60° C., After cooling to ambient temperature 20 ml diethyl ether were added to precipitate the product. After centrifugation, washing with two 20 ml portions of diethylether and drying in vacuum the product was received in quantitative yield. MS (Maldi-TOF): m/e 2042 [M⁺]; 2065 [M⁺+Na].

### Example 20

### Synthesis of Grip 19

19 mg (10 μmol) 17 and 25 mg (100 μmol) p-formyl-benzoic acid-NHS-ester were dissolved in 2 ml dry DMF and stirred for 16 h at 60° C. After cooling to ambient temperature 20 ml diethyl ether were added to precipitate the product. After centrifugation, washing with two 20 ml portions of diethyl ether and drying in vacuum the product was received in quantitative yield. MS (ESI): m/e 2046 [M⁺]; 2066 [M⁺+Na].

### Example 21

### Synthesis of Grip 20

17.4 mg (10 μmol) 7 and 25 mg (100 μmol) p-formyl-benzoic acid-NHS-ester were dissolved in 2 ml dry DMF and stirred for 24 h at 60° C. After cooling to ambient temperature 20 ml diethyl ether were added to precipitate the product. After centrifugation, washing with two 20 ml portions of diethyl ether and drying in vacuum the product was received in quantitative yield. MS (Maldi-TOF): m/e 1877 [M⁺]; 1899 [M⁺+Na].

### Example 22

### Synthesis of N-Butoxycarbonyl-rac.-(3,5-bisethoxycarbonyl-ethylthiomethymesityl)-homocysteine 21

580 mg (1.45 mmol) 1,3,5-Tris-bromomethyl-mesitylene 9 were dissolved in 15 ml toluene. A solution of 420 mg (1.69 mmol) N-tert-butoxycarbonyl-D,L-homocysteine ethyl ester, 430 mg (4.80 mmol) mercaptopropionic acid ethyl ester and 590 mg DBU, dissolved in 30 ml toluene, was added dropwisely over a period of 30 min at ambient temperature. After another 60 min 40 ml 1N hydrochloric acid was added. After the separation of the layers the organic layer was successively washed with each 40 ml of aqueous NaOH (1%), sat. NaHCO₃ and brine. After drying over MgSO₄ and evaporation 973 mg of crude product were received. 320 mg (32%) of the pure product were obtained via chromatography on 300 g silica using toluene/methanol=20/1 (v/v) as eluent. ¹H-NMR (200 MHz, CDCl₃): 1.26 (dt, 9H); 1.43 (s, 9H); 2.04 (m, 2H); 2.43 (s, 9H); 2.61 (m, 6H); 2.81 (m, 4H); 3.77 (ds, 6H-); 4.16 (quint., 6H); 4.38 (d, 1H); 5.17 (d, 1H). ¹³C-NMR (50 MHz, CDCl₃): 14.21/14.25; 15.83/15.87; 28.14/28.34; 29.1; 35.1; 53.1; 79.9; 132.23/132.33; 135.4; 155.4; 171.9/172.2. MS (FAB):m/e 710.2 [M⁺+Na]; 157.1.

### Example 23

### Synthesis of D,L-(3,5-Bisethoxycarbonyl-ethylthiomethy-mesityl)-homocysteine trifluoroacetate 22

410 mg (0.6 mmol) N-Butoxycarbonyl-rac.-(3,5-bisethoxycarbonyl-ethylthiomethymesityl)-homocysteine 21 were dissolved in 20 ml dichloromethane and cooled down to 0° C. 20 ml of trifluoroacetic acid were added dropwisely over a period of 20 min. The solution was stirred at 0° C. for another 1 h at ambient temperature. The solvent and the TFA were removed by evaporation and the residue was 6 times coevaporated with 30 ml portions of chloroform yielding the quantitatively. ¹H-NMR (200 MHz, CDCl₃): 1.16 (t, 9H); 2.1 to 3.0 (m, 21H); 3.67 (s, 6H); 4.07 (m; 7H). ¹³C-NMR (50 MHz, CDCl₃): 13.85/14.18; 15.70/15.79; 28.14/28.38; 32.34/32.57; 35.0; 60.8 63.1; 119.0; 131.9/132.2; 135.47/135.56; 169.3; 172.1. MS (FAB): m/e 588.2 [M⁺−TFA].

### Example 24

### Synthesis of Triamide 23

190 mg (0.27 mmol) of monoamine-trifluoroacetate 22 were suspended in 5 ml chloroform and cooled to 0° C. Successively 110 mg (1.09 mmol) TEA, 48 mg (0.355 mmol) HOBT, a solution of 53 mg (0.09 mmol) triacid 14 in 15 ml chloroform and 62 mg (0.32 mmol) EDC were added. The solution was stirred for 30 min at 0° C., allowed to warm up to room temperature and then stirred for another 15 h at this temperature. The solution was diluted with 50 ml ethyl acetate and was successively washed with 30 ml portions of 1N hydrochloric acid, sat. NaHCO₃ and brine. After drying over MgSO₄ and evaporation 160 mg crude product were received. This was purified by chromatography on 35 g silica using cyclohexane/ethyl acetate 3/2 (v/v) as eluent. 32 mg (15%) of the triamide 23 were isolated. ¹H-NMR: (200 MHz, CDCl₃): 1.27 (br.m; 27H); 1.45(s; 9H); 1.65 (br.s; 6H); 2.44 (br.s; 36H); 2.56-3.10 (br.m; 38H); 3.79 (br.m; 24H); 4.20 (br.m; 18H); 4.56 (br.d; 1H); 4.87 (br.d.; 3H); 5.42 (br.d; 1H); 6.46 (br.d; 3H). MS (ESI): m/e 1101 [(M−Boc)²⁺].

### Example 25

### Synthesis of Monoamine-Nonaester 24

100 mg (43.5 μmol) triamide 23 were dissolved in 20 ml dichloromethane and cooled down to 0° C. 25 ml TFA were added and the solution was stirred for 1 h at this temperature and for an additional hour at room temperature. The solvent and the TFA were removed by evaporation and the residue was coevaporated with five 30 ml portions of chloroform. 110 mg (110%) of the product were obtained. ¹H-NMR: (200 MHz, CDCl₃): 1.27 (br.t; 27H); 2.1-3.3 (m; 82H); 3.78 (br.s; 24H); 4.16 (br.m; 18H); 4.85 (br.m; 3H); 5.47 (br.d; 1H); 5.99(br.s.; 3H); 6.42 (br.d; 1H); 6.67 (br.d; 3H). MS (ESI): m/e 1101 [M²⁺−TFA].

### Example 26

### Synthesis of Monoamine-Nonaacid 25

110 mg (47.6 μmol) monoamine-nonaester 24 were dissolved in 40 ml warm ethanol, 10 ml aqueous NaOH (10%) were added and the mixture was stirred for 15 h at ambient temperature. The solution was concentrated to a final volume of 10 ml by evaporation. The residue was dissolved in 15 ml 0.1 N NaOH and the nonaacid was precipitated by the addition of 6N hydrochloric acid. The solid was isolated by centrifugation and was washed with 15 ml of water and diethyl ether. After drying in vacuum 72 mg of the product 25 were isolated in form of its hydrochloride. MS (ESI): m/e 984 [M²⁺−HCl+Na].

### Example 27

### Synthesis of Grip 26

10 mg (5 μmol) 25 and 12.5 mg (50 μmol) p-formyl-benzoic acid-NHS-ester were dissolved in 1 ml dry DMF and stirred for 16 h at 60° C. After cooling to ambient temperature 10 ml diethyl ether were added to precipitate the product. After centrifugation, washing with two 10 ml portions of diethyl ether and drying in vacuum the product was received in quantitative yield. MS (Maldi-TOF): m/z 2112 [M⁺+Na].

### Example 28

### Silver Staining of Gripped Gold Clusters

1 μl of a 10 μM solution of a gripped gold cluster with ligand 8, as described in example 8, was dropped onto standard filter paper, followed by 20 μl of an 1.5% aqueous solution of p-hydrochinone, which pH was adjusted to 7.0 using acetic acid, and 4 μl of a 1% solution of AgNO₃. This lead to the development of a black spot of colloidal silver within 3 min, whereas a sample of 1 μl water or 1 μl of the buffer alone did not show any result, thus proving the applicability of silver staining on gripped gold clusters.

### Example 29

### Phase Transfer Synthesis of Gripped Gold Clusters

Gripped gold clusters of the grips 18, 19, 20 and 26 were produced according to the general procedure of Example 8.

1-14. (canceled)

15. A conjugatable metal cluster complex comprising
(a) a metal cluster of type Mₖ, and
(b) a multivalent thioether ligand comprising at least two ligand subunits and having one reactive site or one protected reactive site which can be rendered reactive for conjugation, and each of said subunits having at least three thioether moieties.

16. The complex of claim 15 wherein
(i) the metal cluster Mₖ is a cluster wherein M is selected from one or more transition metals, heavy main group metals, in particular noble metals such as Pt, Pd, Ag, Au, including Hg, most preferable is Au, and k is an integer ranging from 10 to 600, preferable is 55; and/or
(ii) the thioether ligand comprises at least three, preferably at least four subunits; and/or
(iii) the subunits are connected through at least one linkage selected from —C(O)O—, —C(O)S—, —C(S)O—, —C(S)S—, —C(O)NH—, —S(O)₂O—, —S(O)₂S—, —S(O)₂NH—, —O—, —S—, —S—S—, —C—C—, —C═C—, —C═N— or —C═N—NH—, preferably a —C(O)NH— moiety; and/or
(iv) the subunits are connected in a linear, cyclic or dendrimeric manner; and/or
(v) the reactive site or protected reactive site which can be rendered reactive for direct conjugation is selected from —NH₂, —OH, —SH, -halogen, and preferable is —NH₂, or for modification and transformation into a monoconjugatable moiety such as an aldehyde, an active ester, a thioester, a hydrazide, a semicarbazide, a phosphoramidite, a vinylsulfone, a isocyanate, a isothiocyanate, a reactive disulfide, preferrable a maleimide, or for transformation into a polymerizable moiety such as an acrylamide or bis- or trisvariants of the moieties listed above; and/or
(vi) the subunit has C₃ symmetry; and/or
(vii) the ligand is in a protected form and attached as a side chain to a suitable protected amino acid, such as a N-Boc or a N-Fmoc amino acid that allow to synthesize peptide conjugates of the grip ligand or oligomers of the grip ligand or combinations of the latter units using standard peptide synthesis protocols and a postsynthetic formation of monomeric or oligomeric gold clusters after deprotection.

17. The complex of claim 15, wherein the thioether ligand has the linear structure (I)
(BₘAB′ₙ)ₚ(BₘAB′ₙ)(BₘAB′ₙ)_{q} (I)
or the cyclic structure (II) 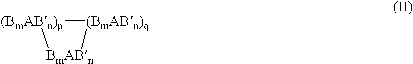
or the dendrimeric structure (III) 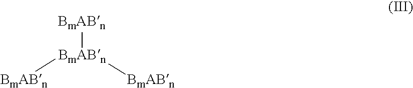
wherein (BₘAB′ₙ) corresponds to one subunit, wherein
(i) A is a core structure selected from substituted or unsubstituted aryl, heteroaryl, cycloalkane or heterocycloalkane residue, or a carbon atom, nitrogen atom, preferably said core structure has C₃ symmetry and more preferable is a substituted or unsubstituted benzene residue, even more preferable the core structure has attached thereto the at least three thioether moieties and/or linear or branched alkyl moieties being directly or through the thioether attached to the core structure;
(ii) B and B′ are lower alkyl or (lower)alkoxy(lower)alkyl moieties substituted by one or more first functional groups selected from —COOH, —COOR′, —OP(O)(OH)₂, —OP(O)(OH)OR′, —OP(O)(OR′)₂, —SH, —SO₂R′, —SO₃H, and —SO₃R′, wherein R′ is a protecting or leaving group;
(iii) B′ is further substituted by at least one second functional group which is selected from —OH, —SH, —NH₂ and a protected form thereof, and preferably is —NH₂ or a protected —NH₂ group, whereby said second functional group of one B′ of the ligand forms the reactive site or protected reactive site which can be rendered reactive for conjugation;
(iv) m, n, p, q are integers each ranging independently from 0 to 25, preferably from 0 to 10, whereby in case of the linear structure (I) m+n≧3 and p+q≧1 and in case of the cyclic structure (II) m+n≧3 and p+q≧2, preferably in any case m+n=3 and p+q=3; and/or
(v) at least two subunits are bonded to each other through a covalent B-B′ linkage which is achieved by reaction of the first functional group of B with the second functional group of B′, or a linkage between B and B′ obtained by reaction with one ore more additional bisfunctional linker molecules.

18. The complex of claim 17, wherein the subunit corresponds to the formula (IV) 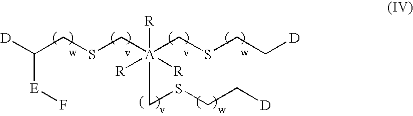
wherein,
(i) A is a core structure selected from substituted or unsubstituted aryl, heteroaryl, cycloalkane or heterocycloalkane residue, or a carbon atom, nitrogen atom, preferably said core structure has C₃ symmetry and more preferable is a substituted or unsubstituted benzene residue, even more preferable the core structure has attached thereto the at least three thioether moieties and/or linear or branched alkyl moieties being directly or through the thioether attached to the core structure, preferably a 1,3,5 trisubstituted benzene optionally having 1 to 3 additional substituents R;
(ii) R is independently selected from H or lower alkyl, preferably any of H, —CH₃, —C₂H₅, or halogen;
(iii) D is the first functional group;
(iv) E is the second functional group;
(v) F is H or a protecting group and for one subunit of the ligand F is H or a protecting group or a functional group or a moiety which can be rendered functional selected from —NH₂, —CHO, —OH, -halogen, —SH, and —SS so that the E-F moiety forms the reactive site or protected reactive site which can be rendered reactive for conjugation; and/or
(vi) v and w are integers each ranging independently from 0 to 10, preferably is 1.

19. The complex of claim 18, wherein
(i) A is a benzene residue;
(ii) R is hydrogen; and
(iii) D is COOH; and
(iv) E is —NH₂ and F is H and for one subunit of the ligand F is a moiety of formula (V) 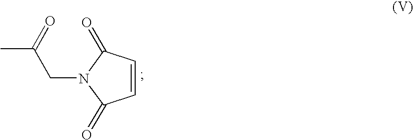
or an ω-aminocarboxylic acid or an α,ω-diaminocarboxylic analogue of the moiety of formula (V), or any other NH₂ protecting group, such as a N-Boc or a N-Fmoc amino acid, or E-F represents any other protected functional group that renders reactive —NH₂, —OH, —SH, -halogen; and
(v) v=1 and w=1; and/or
(vi) p=1 and q=2; and/or
(vii) the subunits are connected in a dendrimeric manner; and/or
(viii) the metal cluster preferably is Au₅₅.

20. The complex of claim 15 which has a ligand which has a subunit additionally comprising a first carbohydrate, peptide, nucleotide, peptide-nucleic acid (PNA), p-RNA, or polyether, preferably an oligonucleotide attached to the reactive site through a covalent bond.

21. The complex of claim 15 wherein the ligand has the structure of formula (VI): 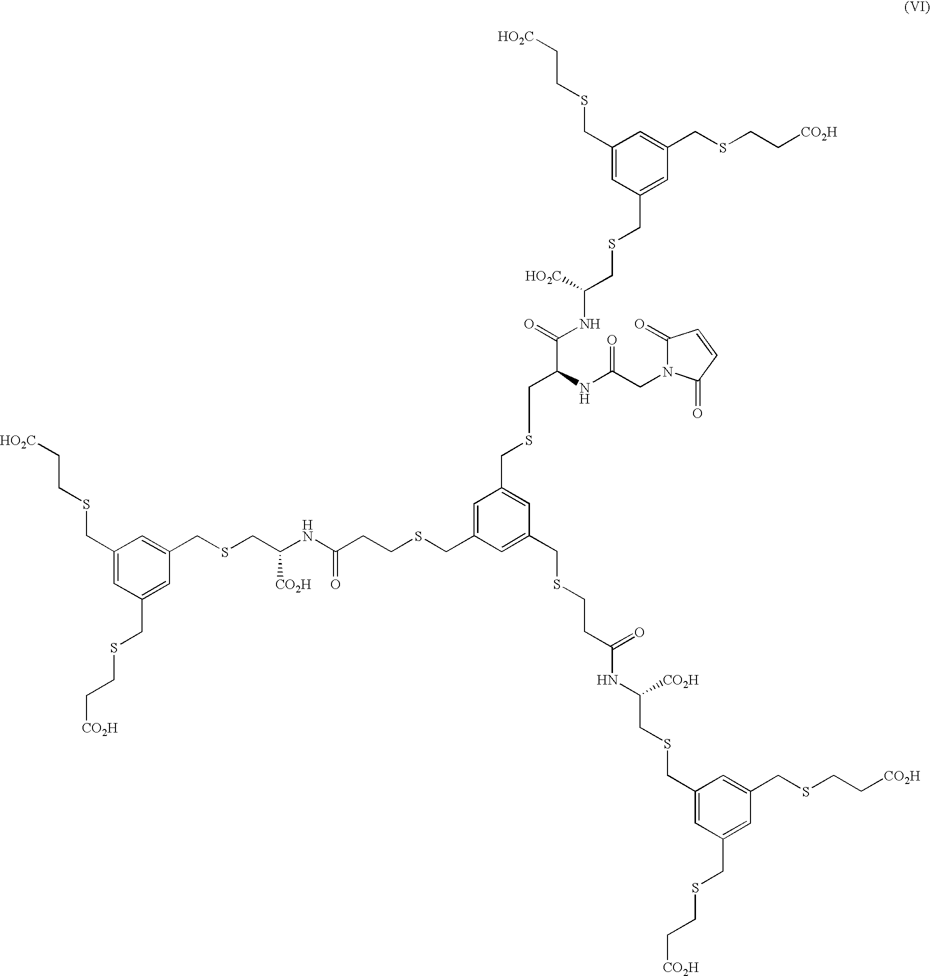
or derivatives thereof having substituents R at the benzene cores, wherein R is selected from H or a lower alkyl, preferably any of H, —CH₃, —C₂H₅, halogen, and dia- and enantio-stereoisomeres thereof.

22. The ligand as defined in claim 15.

23. The subunit as defined in claim 18.

24. A method for preparing the ligand of claim 22, which method comprises the following steps of
(i) preparing the subunit comprising the formula IV, 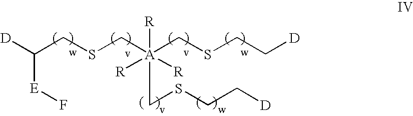
wherein,
(a) A is a core structure selected from substituted or unsubstituted aryl, heteroaryl, cycloalkane or heterocycloalkane residue, or a carbon atom, nitrogen atom, preferably said core structure has C₃ symmetry and more preferable is a substituted or unsubstituted benzene residue, even more preferable the core structure has attached thereto the at least three thioether moieties and/or linear or branched alkyl moieties being directly or through the thioether attached to the core structure, preferably a 1,3,5 trisubstituted benzene optionally having 1 to 3 additional substituents R;
(b) R is independently selected from H or lower alkyl, preferably any of H, —CH₃, —C₂H₅, or halogen;
(c) D is the first functional group;
(d) E is the second functional group;
(e) F is H or a protecting group and for one subunit of the ligand F is H or a protecting group or a functional group or a moiety which can be rendered functional selected from —NH₂, —CHO, —OH, -halogen, —SH, and —SS so that the E-F moiety forms the reactive site or protected reactive site which can be rendered reactive for conjugation; and/or
(f) v and w are integers each ranging independently from 0 to 10, preferably is 1; and
(ii) coupling together at least two subunits obtained in step (i), whereby one of the subunits coupled together has a reactive site or protected reactive site which can be rendered reactive for conjugation; and
(iii) optionally deprotection.

25. The method of claim 24, which comprises one or more of the steps of
(i) reacting a compound of formula (VII) 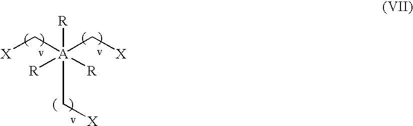
wherein A is a core structure selected from substituted or unsubstituted aryl, heteroaryl, cycloalkane or heterocycloalkane residue, or a carbon atom, nitrogen atom, preferably said core structure has C₃ symmetry and more preferable is a substituted or unsubstituted benzene residue, even more preferable the core structure has attached thereto the at least three thioether moieties and/or linear or branched alkyl moieties being directly or through the thioether attached to the core structure, preferably a 1,3,5 trisubstituted benzene optionally having 1 to 3 additional substituents R; R is independently selected from H or lower alkyl, preferably any of H, —CH₃, —C₂H₅, or halogen; v is an integer ranging from 0 to 10, preferably is 1; and X is a leaving group, with the compounds of formula (VIII) and (IX) separately or with a mixture of the compounds of formula (VIII) and (IX), 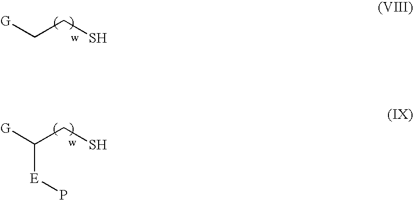
wherein G is —COOH, —COOR′, —OP(O)(OH)₂, —OP(O)(OH)OR′, —OP(O)(OR′)₂, —SH, —SO₂R′, —SO₃H, —SO₃R′, wherein R′ is a protecting or leaving group, P is a protecting group, E is a second functional group, and w is an integer ranging from 0 to 10, preferably is 1 to obtain the compound of formula (X) 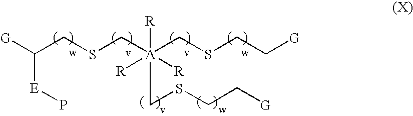
(ii) reacting the compound of formula (X) with a suitable base or acid to obtain the compound of formula (XI) 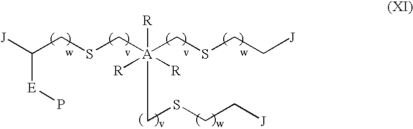
wherein J is selected from any of —COOH, —OP(O)(OH)OR′, —SH, and —SO₃H;
(iii) reacting the compound of formula (X) with a suitable base or acid to obtain the compound of formula (XII) 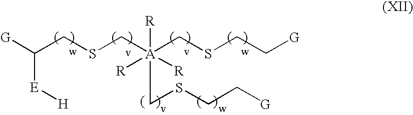
(iv) reacting the compound of formula (XI) with the compound of formula (XII), preferably in a molar ratio of (XI):(XII)≧1:3, and in the presence of one or more suitable activating reagents;
(v) reacting the compound obtained in step (iv) with a reagent suitable to remove the protecting group P;
(vi) reacting the compound obtained in step (v) with a suitable base or acid to convert all G-groups to J-groups;
(vii) optionally reacting the free E-H group of the compound obtained in step (vi) with a reagent of formula F—Y or F—H, and Y is a suitable leaving group, and, in case F—H is employed, in the presence of a suitable water removing agent, to obtain the ligand, or a compound, wherein J is different from D; and
(viii) in case for the compound obtained in step (vii) J is different from D, all J-groups of said compound are converted to D-groups to obtain the ligand.

26. A method for preparing the ligand as defined in claim 21, which method comprises steps
(i) reacting a compound of formula (VII) 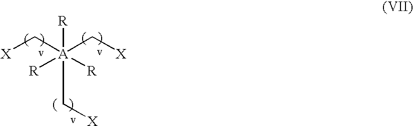
wherein A is a core structure selected from substituted or unsubstituted aryl, heteroaryl, cycloalkane or heterocycloalkane residue, or a carbon atom, nitrogen atom, preferably said core structure has C₃ symmetry and more preferable is a substituted or unsubstituted benzene residue, even more preferable the core structure has attached thereto the at least three thioether moieties and/or linear or branched alkyl moieties being directly or through the thioether attached to the core structure, preferably a 1,3,5 trisubstituted benzene optionally having 1 to 3 additional substituents R; R is independently selected from H or lower alkyl, preferably any of H, —CH₃, —C₂H₅, or halogen; v is an integer ranging from 0 to 10, preferably is 1; and X is a leaving group, with the compounds of formula (VIII) and (IX) separately or with a mixture of the compounds of formula (VIII) and (IX), 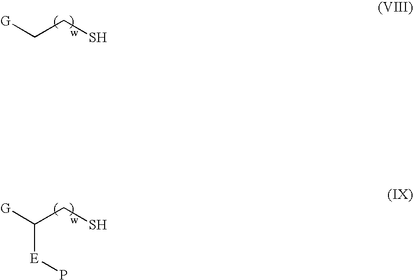
wherein G is —COOH, —COOR′, —OP(O)(OH)₂, —OP(O)(OH)OR′, —OP(O)(OR′)₂, —SH, —SO₂R′, —SO₃H, —SO₃R′, wherein R′ is a protecting or leaving group, P is a protecting group, E is a second functional group, and w is an integer ranging from 0 to 10, preferably is 1 to obtain the compound of formula (X) 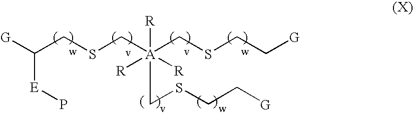
; and
(ii) reacting the compound of formula (X) with a suitable base or acid to obtain the compound of formula (XI) 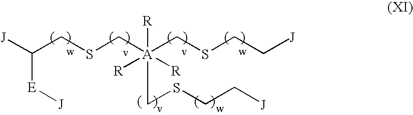
wherein J is selected from any of —COOH, —OP(O)(OH)OR′, —SH, and —SO₃H; or
(iii) reacting the compound of formula (X) with a suitable base or acid to obtain the compound of formula (XII)

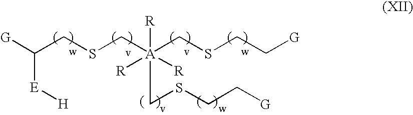

27. A method for preparing the complex as defined in claim 15, comprising reacting the ligand with the metal cluster.

28. The method of claim 27 which further comprises reduction of a precursor for the metal cluster, preferably HAuCl₄, manipulation of conjugates by inductive heating using radio frequency in the presence of the ligand thus forming the cluster.

29. Use of the complex as defined in claim 15 in a polymerase chain reaction (PCR), for labeling of a carbohydrate, peptide, nucleotide, peptide nucleic acid (PNA), p-RNA, polyether, for quenching the fluorescence of one or more fluorescence labels, for the identification of a nucleotide, peptide-nucleotide-adduct (PNA) or oligonucleotide, as TEM-Labels, for immunostaining, for silver staining, etc.
